(19) United States
(12) Patent Application Publication
(10) Pub. No.: US 2025/0294438 A1
(43) Pub. Date: Sep. 18, 2025

(54) COMMUNICATION DEVICE, IMAGE PROCESSING DEVICE, AND NON-TRANSITORY COMPUTER-READABLE RECORDING MEDIUM STORING COMPUTER-READABLE INSTRUCTIONS FOR COMMUNICATION DEVICE AND IMAGE PROCESSING DEVICE

(71) Applicant: BROTHER KOGYO KABUSHIKI KAISHA, Nagoya (JP)

(72) Inventor: Seiya YOSHIDA, Nagoya (JP)

(21) Appl. No.: 19/061,315

(22) Filed: Feb. 24, 2025

(30) Foreign Application Priority Data
Mar. 14, 2024 (JP) 2024-040309

(51) Int. Cl. H04W 48/18; G06F 3/12; H04W 84/12

(52) U.S. Cl. CPC H04W 48/18; G06F 3/1203; G06F 3/1236; G06F 3/1287; H04W 84/12

(57) ABSTRACT

A communication device is configured to search for one or more image processing devices which do not currently belong to a same Wi-Fi network to which the communication device belongs according to a first scheme of the Wi-Fi standard, for each of M image processing devices found in the search, specify a distance between the image processing device and the communication device, cause an output unit to output N identification information for identifying N image processing devices among the M image processing devices based on the specified distances of the M image processing devices, in a case where specific identification information is selected by a user, join, via the Wi-Fi interface, a same Wi-Fi network to which a specific image processing device belongs according to a second scheme of the Wi-Fi standard, and send a process instruction to the specific image processing device by using the Wi-Fi network.

### REFERENCE TO RELATED APPLICATION

This application claims priority to Japanese Patent Application No. 2024-040309 filed on Mar. 14, 2024. The entire content of the priority application is incorporated herein by reference.

### BACKGROUND ART

A terminal device is known that acquires distances between the terminal device and multiple printers in which printing may be executed. The terminal device preferentially extracts a printer that is a short distance away from the terminal device and causes the extracted printer to execute printing.

### SUMMARY

The disclosure herein provides a novel technology for a communication device to cause an image processing device to execute image processing.

A communication device is disclosed herein. The communication device may comprise a Wi-Fi interface configured for Wi-Fi communication according to a Wi-Fi standard and a controller. The controller may be configured to: search for one or more image processing devices present around the communication device via the Wi-Fi interface according to a first scheme of the Wi-Fi standard, wherein the one or more image processing devices do not currently belong to a same Wi-Fi network to which the communication device belongs; for each of M image processing devices found in the search, specify a distance between the image processing device and the communication device, wherein the M is an integer equal to or greater than 1; cause an output unit to output N identification information for identifying N image processing devices among the M image processing devices based on the specified distances of the M image processing devices, wherein the N is an integer equal to or greater than 1 and equal to or less than the M; in a case where specific identification information is selected by a user from the N identification information, join, via the Wi-Fi interface, a same Wi-Fi network to which a specific image processing device identified by the specific identification information belongs according to a second scheme of the Wi-Fi standard different from the first scheme; and send a process instruction for instructing image processing to be executed to the specific image processing device via the Wi-Fi interface by using the Wi-Fi network.

According to the configuration above, the communication device searches for one or more image processing devices that do not currently belong to the same Wi-Fi network to which the communication device belongs according to the first scheme of the Wi-Fi standard, and then outputs the N identification information based on the distances of the M image processing devices from the communication device. In response to specific identification information being selected by the user from the N identification information, the communication device joins the same Wi-Fi network to which the specific image processing device identified by the specific identification information belongs according to the second scheme of the Wi-Fi standard, and then sends the process instruction to the specific image processing device. Thus, a novel technology for the communication device to cause an image processing device to execute image processing is achieved.

A specific image processing device is also disclosed herein. The specific image processing device may comprise an image processing unit, a Wi-Fi interface configured for Wi-Fi communication according to a Wi-Fi standard, and a controller. The controller may be configured to: in a case where a search signal according to a first scheme of the Wi-Fi standard is received via the Wi-Fi interface from a communication device that does not currently belong to a same Wi-Fi network to which the specific image processing device belongs, send the communication device a response signal according to the first scheme, wherein based on response signals sent from M image processing devices including the specific image processing device, N identification information for identifying N image processing devices among the M image processing devices is outputted in the communication device, wherein the M is an integer equal to or greater than 1 and the N is an integer equal to or greater than 1 and equal to or less than the M; in a case where specific identification information for identifying the specific image processing device is selected by a user from the N identification information, join, via the Wi-Fi interface, a same Wi-Fi network to which the communication device belongs according to a second scheme of the Wi-Fi standard different from the first scheme; receive a process instruction for instructing image processing to be executed from the communication device via the Wi-Fi interface by using the Wi-Fi network; and in a case where the process instruction is received from the communication device, cause the image processing unit to execute the image processing.

According to the configuration above, in response to receiving the search signal from the communication device that does not currently belong to the same Wi-Fi network to which the specific image processing device belongs according to the first scheme of the Wi-Fi standard, the specific image processing device sends the response signal to the communication device. Then, in response to specific identification information for identifying the specific image processing device being selected by the user in the communication device from the N identification information, the specific image processing device joins the same Wi-Fi network to which the communication device belongs according to the second scheme of the Wi-Fi standard, receives the process instruction from the communication device, and causes the image processing unit to execute image processing. Thus, a novel technology for the communication device to cause an image processing device to execute image processing is achieved.

Computer-readable instructions for the above communication device, a non-transitory computer readable recording medium storing the computer-readable instructions, and a method carried out by the communication device are also novel and useful. Further, computer-readable instructions for the above specific image processing device, a non-transitory computer readable recording medium storing the computer-readable instructions, and a method carried out by the specific image processing device are also novel and useful. Further, a system comprising the above communication device and the above specific image processing device is also novel and useful.

### BRIEF DESCRIPTION OF DRAWINGS

FIG. 1 is a diagram schematically showing a communication system.

FIG. 2 is a diagram showing hardware configurations of devices constituting the communication system.

FIG. 3 is a sequence diagram of a process executed between devices.

FIG. 4 is a sequence diagram continued from FIG. 3.

FIG. 5 is a sequence diagram of a distance measuring process.

### DESCRIPTION

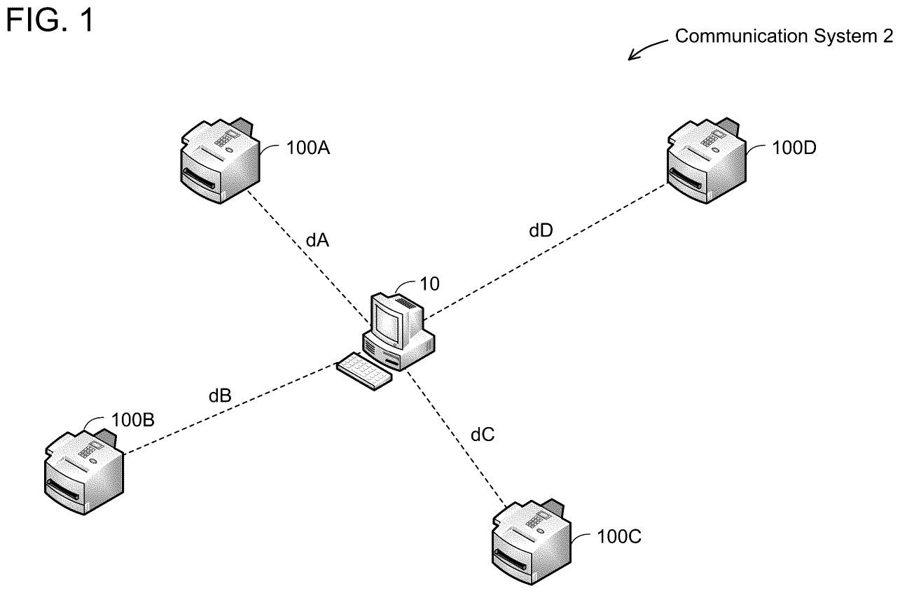

### Communication System 2; FIG. 1

As shown in FIG. 1, a communication system 2 comprises a terminal 10 and a plurality of printers 100A to 100D. The devices 10 and 100A to 100D are installed, for example, in places within an office. The printers 100A to 100D are distances dA to dD away from the terminal 10, respectively. In this embodiment, the distances dA to dD are in a relation of dA<dB<dC<dD. The terminal 10 may be a stationary terminal device or a portable terminal device. In the latter case, distances between the terminal 10 and the printers 100A to 100D may vary.

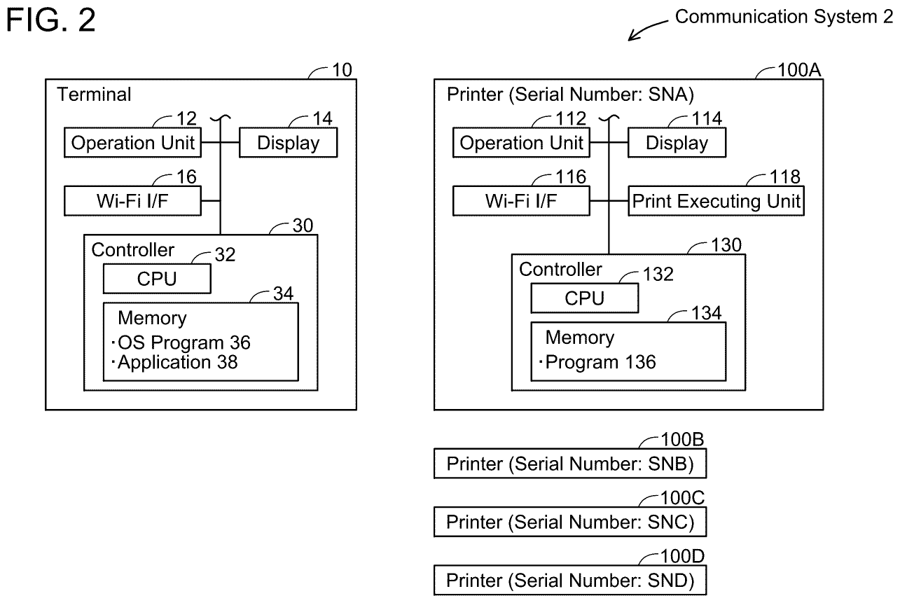

### Hardware Configurations of Devices; FIG. 2

Referring now to FIG. 2, hardware configurations of the devices 10 and 100A to 100D, which constitute the communication system 2, are described.

### Configuration of Terminal 10

In this embodiment, the terminal 10 is a stationary PC. In a modification, the terminal 10 may be a portable terminal device such as a mobile phone, a smartphone, a PDA, a tablet PC, a laptop PC, or the like. The terminal 10 comprises an operation unit 12, a display 14, a Wi-Fi interface 16, and a controller 30. The units 12 to 30 are connected to a bus line. Hereinafter, an interface is abbreviated as “I/F”.

The operation unit 12 is an I/F through which a user can input various information to the terminal 10 and comprises, for example, a touch screen and/or buttons. The user can input various information to the terminal 10 through the operation unit 12. The display 14 is a display for displaying various information.

The Wi-Fi I/F 16 is a wireless I/F for Wi-Fi communication according to Wi-Fi standard. The Wi-Fi standard is a wireless communication standard for wireless communication according to, for example, 802.11 standard of the Institute of Electrical and Electronics Engineers, Inc. (IEEE) and standards in compliance therewith such as 802.11a, 11b, 11g, 11n, and 11ac. Especially, the Wi-Fi I/F 16 supports a Wi-Fi Aware scheme established by the Wi-Fi Alliance. Wi-Fi Aware is described in detail in the specification called “Wi-Fi Aware Specification Version 4.0” created by the Wi-Fi Alliance.

Although will be described later in detail, the devices 10 and 100A to 100D join a Neighbor Awareness Network (NAN) cluster according to the Wi-Fi Aware scheme. Among devices within the same NAN cluster, their Discovery Windows are synchronized. A Discover Window is a period for sending and receiving signals.

The devices within the NAN cluster play any one of roles called Master, Anchor Master, and Non-Master. A Master is capable of sharing timer information, searching for services, and inviting a device to the NAN cluster. In addition to the Master's functions, an Anchor Master is also capable of setting timer information for synchronization. A Non-Master is capable of sharing timer information and searching for services but incapable of inviting a device to the cluster.

Each device within the NAN cluster can search for other devices within the NAN cluster (more specifically, services provided by the other devices). A signal for searching for a service is called ‘Subscribe’. A device that has received a Subscribe sends a response signal called ‘Publish’. In this embodiment, the terminal 10 sends a Subscribe to search for other devices that provide printing services. Since the printers 100A to 100D provide printing services, each of them sends the terminal 10 a Publish indicating that it provides a printing service. Thus, the terminal 10 can find the printers 100A to 100D.

The Subscribe and Publish described above are communicated using layers that are lower than the network layer of the OSI reference model. That is, the above-described search is executed without executing communication of the network layer or higher layer of the OSI reference model. A pair of devices within the same NAN cluster is incapable of executing communication of the network layer or higher layer of the OSI reference model unless they establish a connection through pairing. In this embodiment, a state where a device simply belongs to a NAN cluster, i.e., a state where a device is incapable of executing communication of the network layer or higher layer with another device within a NAN cluster is phrased as “the device does not belong to the same Wi-Fi network to which the other device belongs”, while a state where a device is capable of executing communication of the network layer or higher layer with another device within a NAN cluster is phrased as “the device belongs to the same Wi-Fi network to which the other device belongs”.

The Wi-Fi I/F 16 also supports Wi-Fi Direct scheme established by the Wi-Fi Alliance. Wi-Fi Direct is a registered trademark of the Wi-Fi Alliance. Hereinafter, Wi-Fi Direct is abbreviated as “WFD”. WFD is described in detail in the specification called “Wi-Fi Direct Specification Version 1.9” created by the Wi-Fi Alliance. Hereinafter, a Wi-Fi connection established according to the WFD scheme is termed “WFD connection”. Once a WFD connection is established between a pair of devices, the devices are capable of executing communication of the network layer or higher layer of the OSI reference model and belong to the same Wi-Fi network.

The controller 30 comprises a CPU 32 and a memory 34. The memory 34 comprises a main storage and an auxiliary storage. The main storage includes, for example, a RAM, a cache memory, etc. The auxiliary storage may be, for example, a flash memory, a solid state drive (SSD), a ROM, or a combination thereof. An OS program 36 and an application program 38 are stored in the auxiliary storage. The CPU 32 implements various processes according to the programs 36 and 38 loaded from the auxiliary storage to the main storage. Hereinafter, the OS program is abbreviated as “OS” and the application program is abbreviated as “app”.

The OS 36 controls basic operations of the terminal 10. The app 38 causes the OS 36 to execute processes according to the Wi-Fi Aware scheme to establish a Wi-Fi connection between the terminal 10 and a printer. The app 38 also sends print data representing an image to be printed to the printer using the Wi-Fi connection (i.e., using the Wi-Fi network to which the terminal 10 and the printer both belong). The app 38 is downloaded, for example, from a server on the internet and installed in the terminal 10.

### Configurations of Printers 100A to 100D

The printers 100A to 100D are peripheral devices capable of executing a print function (e.g., peripheral devices of the terminal 10). In a modification, the printers 100A to 100D may be multifunctional devices capable of executing a scan function, facsimile function, and the like in addition to the print function. The printer 100A has a serial number SNA for identifying the printer 100A. The printer 100A comprises an operation unit 112, a display 114, a Wi-Fi I/F 116, a print executing unit 118, and a controller 130. The units 112 to 130 are connected to a bus line.

The operation unit 112 is an I/F through which a user can input various information to the printer 100A and comprises, for example, a touch screen and/or buttons. The user can input various information to the printer 100A through the operation unit 112. The display 114 is a display for displaying various information. As with the Wi-Fi I/F 16 of the terminal 10, the Wi-Fi I/F 116 supports the Wi-Fi Aware scheme and the Wi-Fi Direct scheme. The print executing unit 118 comprises, for example, a print mechanism of an inkjet scheme or a laser scheme.

The controller 130 comprises a CPU 132 and a memory 134. The memory 134 comprises a main storage and an auxiliary storage. A program 136 is stored in the auxiliary storage. The CPU 132 implements various processes according to the program 136 loaded to the main storage from the auxiliary storage.

The printers 100B to 100D have the same configuration as that of the printer 100A except that the printers 100B to 100D have serial numbers SNB to SND, respectively.

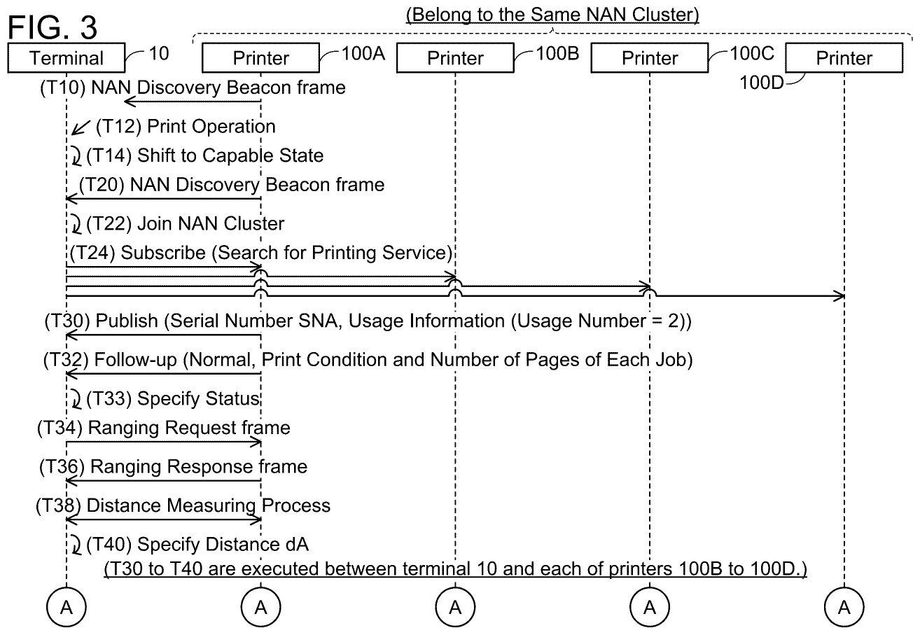

### Process Executed Between Devices; FIG. 3

Referring now to FIG. 3, a process executed by the devices 10 and 100A to 100D is described. Hereinafter, in order to facilitate understanding, actions of the CPUs (e.g., 32, 132) of the devices (e.g., the terminal 10, the printers 100A to 100D) are described as if the devices executed the actions. Further, communication between the devices is executed via the Wi-Fi I/Fs (e.g., 16, 116). Thus, a phrase “via the Wi-Fi I/F” is omitted in communication-related descriptions hereinafter.

In the initial state of FIG. 3, the printers 100A to 100D belong to the same NAN cluster. In the present case, the printer 100A operates as an Anchor Master within the NAN cluster, and each of the printers 100B to 100D operates as a Master within the NAN cluster. Further, in the initial state of FIG. 3, the app 38 has not been activated yet and the terminal 10 is incapable of receiving signals according to the Wi-Fi Aware scheme. Here, “the terminal 10 is incapable of receiving signals according to the Wi-Fi Aware scheme” means that the Wi-Fi I/F 16 does not receive signals according to the Wi-Fi Aware scheme from external devices. In a modification, “the terminal 10 is incapable of receiving signals according to the Wi-Fi Aware scheme” may mean that the Wi-Fi I/F 16 receives signals according to the Wi-Fi Aware scheme from external devices but the CPU 32 does not execute a process according to the received signals (i.e., ignores the received signals). Hereinafter, the state of being incapable of receiving signals according to the Wi-Fi Aware scheme is termed “incapable state”.

In T10, the printer 100A sends a NAN Discovery Beacon frame (termed “Discovery” hereinafter) by broadcasting. The Discovery is a signal according to the Wi-Fi Aware scheme that advises information related to the NAN cluster to which the printer 100A belongs to external devices. Devices that do not belong to the NAN cluster can join the NAN cluster by receiving the Discovery. That is, the Discovery can be also construed as a signal for inviting devices that do not belong to the NAN cluster to the NAN cluster. The printer 100A periodically sends a Discovery. Each of the printers 100B to 100D, which are Masters, also periodically sends a Discovery, although this is not shown. Since the terminal 10 is in the incapable state at the time of T10, the terminal 10 does not receive the Discovery from the printer 100A in T10.

In T12, the terminal 10 receives a print operation from the user. For example, the print operation is an operation of selecting an image to be printed via the app 38. Since the app 38 is activated in the terminal 10, the terminal 10 executes processes according to the app 38 after receiving the print operation. In T14, the terminal 10 shifts from the incapable state to a state where the terminal 10 is capable of receiving signals according to the Wi-Fi Aware scheme. Here, “the terminal 10 is capable of receiving signals according to the Wi-Fi Aware scheme” means that the Wi-Fi I/F 16 receives signals according to the Wi-Fi Aware scheme from external devices and the CPU 32 is capable of executing processes according to the received signals. Hereinafter, the state of being capable of receiving signals according to the Wi-Fi Aware scheme is termed “capable state”.

In T20, the printer 100A sends a Discovery. Since the terminal 10 is in the capable state at the time of T20, the terminal 10 receives the Discovery from the printer 100A in T20. The terminal 10 then joins the NAN cluster in T22. As a result, the terminal 10 and the printers 100A to 100D belong to the same NAN cluster. However, as described above, the terminal 10 is still incapable of executing communication of the network layer or higher layer of the OSI reference model with the printer 100A, etc. at this time. That is, the terminal 10 does not belong to the same Wi-Fi network to which the printer 100A, etc. belong. Once having joined the NAN cluster, the terminal 10 executes communication with the printer 100A to determine its role within the NAN cluster, although this is not shown. In the present case, the terminal 10 operates as a Non-Master.

In T24, the terminal 10 sends a Subscribe by broadcasting within the NAN cluster to search for devices that provide printing services. In the present case, this Subscribe is sent to the printers 100A to 100D within the NAN cluster.

In response to receiving the Subscribe from the terminal 10 in T24, the printer 100A sends a Publish to the terminal 10 in T30. This Publish includes the serial number SNA of the printer 100A and usage information indicating a usage of the printer 100A. The usage information includes a usage number of the printer 100A. The usage number is a sum of the number of devices that currently have one-on-one connections (e.g., WFD connections) with the printer 100A (this number is termed “first number” hereinafter) and the number of devices that currently have sessions for communicating with the printer 100A (this number is termed “second number” hereinafter). Here, “session” means communication according to a specific protocol (e.g., HTTP) that is established, while the printer 100A belongs to a Wi-Fi network formed by an access point, between an external device and the printer 100A in response to an operation to instruct printing to be executed being performed on the external device. When the operation unit 112 of the printer 100A is being operated, the usage number is the sum of the first and second numbers plus “1”. In other words, the usage number can be rephrased as the number of users that can currently use the printer 100A. In the present case, the usage number of the printer 100A is 2.

In T32, the printer 100A sends a ‘Follow-up’ to the terminal 10. This Follow-up is a signal to provide further information related to the printing service to the terminal 10, and includes information indicating that the printer 100A is operating normally and information related to unexecuted jobs currently scheduled in the printer 100A (e.g., a print condition (such as paper size etc.), the number of pages to be printed, etc. of each unexecuted job). The Follow-up is also a signal communicated using a layer that is lower than the network layer of the OSI reference model. For example, if an error (e.g., lack of paper, lack of ink, etc.) is occurring in the printer 100A, the Follow-up includes error information indicative of the error instead of the information indicating that the printer 100A is operating normally.

The terminal 10 receives the Publish from the printer 100A in T30 and receives the Follow-up from the printer 100A in T32. Then, the terminal 10 specifies a status of the printer 100A and stores it in T33. Here, “status” means the usage number included in the usage information and each information included in the Follow-up.

In T34, the terminal 10 sends a Ranging Request frame to the printer 100A. The Ranging Request frame is a signal that requests a process for measuring a distance between the terminal 10 and the printer 100A to be executed. The Ranging Request frame is also a signal communicated using a layer that is lower than the network layer of the OSI reference model.

In response to receiving the Ranging Request frame from the terminal 10 in T34, the printer 100A sends a Ranging Response frame to the terminal 10 in T36. The Ranging Response frame is also a signal communicated using a layer that is lower than the network layer of the OSI reference model.

The terminal 10 receives the Ranging Response frame from the printer 100A in T36. In response, a distance measuring process is executed between the terminal 10 and the printer 100A in T38.

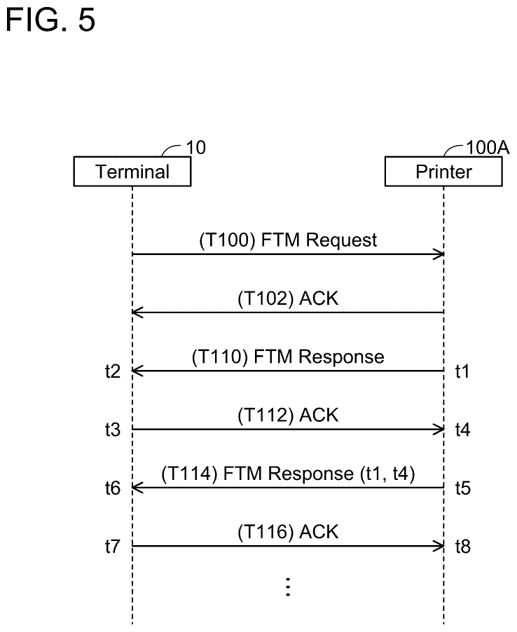

### Distance Measuring Process; FIG. 5

Referring now to FIG. 5, the distance measuring process executed in T38 of FIG. 3 is described. In T100, the terminal 10 sends a Fine Timing Measurement (FTM) request to the printer 100A. FTM is a protocol for measuring a distance between devices using Wi-Fi communication. The FTM request is a signal that requests the FTM to be started and includes, for example, information related to frequency bands used for various FTM communications.

In response to receiving the FTM request from the terminal 10 in T100, the printer 100A sends an ACK to the terminal 10 in T102. In response, the FTM is started from T110.

In the FTM, the printer 100A first sends an FTM response to the terminal 10 in T110. At this time, the printer 100A stores a time t1 at which the FTM response was sent.

The terminal 10 receives the FTM response from the printer 100A in T110. At this time, the terminal 10 stores a time t2 at which the FTM response was received. The terminal 10 then sends an ACK to the printer 100A in T112. At this time, the terminal 10 stores a time t3 at which the ACK was sent.

The printer 100A receives the ACK from the terminal 10 in T112. At this time, the printer 100A stores a time t4 at which the ACK was received.

The printer 100A then sends an FTM response to the terminal 10 in T114. This FTM response includes the stored time t1 and time t4. Further, the printer 100A stores a time t5 at which the FTM response was sent in T114.

The terminal 10 receives the FTM response from the printer 100A in T114. At this time, the terminal 10 stores a time t6 at which the FTM response was received.

The terminal 10 calculates a distance between the terminal 10 and the printer 100A by using the stored times t2 and t3 and the times t1 and t4 included in the FTM response received in T114. Specifically, the terminal 10 first calculates RTT1=(t4−t1)−(t3−t2). The RTT1 is the sum of a time period took to send the FTM response of T110 and a time period took to send the ACK of T112. That is, the RTT1 is a time period took for one cycle of communication between the terminal 10 and the printer 100A. The terminal 10 then calculates the distance between the terminal 10 and the printer 100A by a formula ((c×RTT1)/2), where c is light speed. Thus, the terminal 10 can calculate the distance between the terminal 10 and the printer 100A using the times t1 and t2 related to the communication of the FTM response and the times t3 and t4 related to the communication of the ACK.

In T116, the terminal 10 sends an ACK to the printer 100A. At this time, the terminal 10 stores a time t7 at which the ACK was sent.

The printer 100A receives the ACK from the terminal 10 in T116. At this time, the printer 100A stores a time t8 at which the ACK was received.

Thereafter, the terminal 10 and the printer 100A repeat communicating an FTM response and an ACK predetermined times. The terminal 10 calculates a distance between the terminal 10 and the printer 100A for each cycle of communication of an FTM response and an ACK. For example, for the FTM response of T114 and the ACK of T116, a distance between the terminal 10 and the printer 100A is calculated by a formula ((c×RTT2)/2), where RTT2=(t8−t5)−(t7−t6). The terminal 10 calculates the distance between the terminal 10 and the printer 100A by calculating an average of the distances calculated predetermined times.

Returning to FIG. 3, the terminal 10 specifies the distance dA between the terminal 10 and the printer 100A in T40 of FIG. 3 after the distance measuring process of FIG. 5. After this, the sequence from T30 to T40 is executed between the terminal 10 and each of the printers 100B to 100D. Thereby, the terminal 10 specifies statuses of the printers 100B to 100D and the distances dB to dD between the terminal 10 and the printers 100B to 100D. Especially, in this embodiment, the terminal 10 can execute the communication of T24 to T38 to specify the statuses and distances of the printers 100A to 100D before the terminal 10 joins the Wi-Fi network to which the printer 100A, etc. belong.

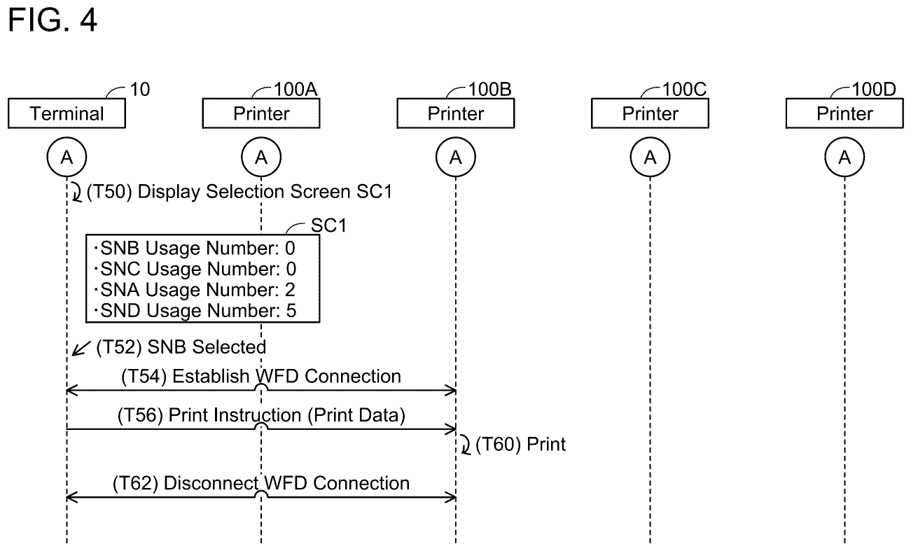

Continuation from FIG. 3; FIG. 4

After having specified the statuses and the distances dA to dD of the printers 100A to 100D, the terminal 10 displays a selection screen SC1 on the display 14 in T50. The selection screen SC1 includes the serial numbers for identifying the printers 100A to 100D and the usage numbers of the printers associated with the serial numbers. Specifically, the terminal 10 creates the selection screen SC1 as described below.

First, for each of the distances dA to dD, the terminal 10 determines whether the distance is less than a predetermined distance. The terminal 10 eliminates one or more serial numbers of the printers that are the predetermined distance or more away from the terminal 10, from candidates to be displayed in the selection screen SC1. In the present case, the terminal 10 determines that all the distances dA to dD are less than the predetermined distance. That is, none of the serial numbers of the printers are eliminated from candidates to be displayed in the selection screen SC1.

Then, for the printers 100A to 100D identified by the serial numbers to be displayed, the terminal 10 specifies the usage numbers included in the statuses of the printers. The terminal 10 then lists the serial numbers of the printers 100A to 100D such that the serial numbers of printers with smaller usage numbers are arranged closer to the top of the list in the selection screen SC1. That is, the terminal 10 preferentially displays printers with smaller usage numbers. Further, the terminal 10 associates the serial numbers with the corresponding usage numbers of the printers identified by the serial numbers. In this embodiment, “associate a serial number with a usage number” means that the usage number is written on the right side of the serial number, however, the usage number may be written below or on the left side of the serial number. Generally, “associate a serial number with a usage number” may mean that the usage number is written anywhere near the serial number.

If two or more of the printers have the same usage number, the terminal 10 preferentially displays printers that are smaller distances away from the terminal 10. In the present case, two printers 100B and 100C have the same usage number “0”, and the serial number SNB of the printer 100B which is a smaller distance away from the terminal 10 than the printer 100C is displayed above the serial number SNC of the printer 100C. Since the selection screen SC1 created as above is displayed, the user can easily recognize that he/she can get a printed material faster by causing printers having serial numbers listed near the top to execute printing. Thus, user convenience is improved.

If two or more of the printers have the same usage number and are the same distance away from the terminal 10, the terminal 10 may determine the display order based on the information included in their Follow-ups. For example, the terminal 10 may arrange a normally operating printer above a printer in which an error is occurring, or may arrange printers having smaller numbers of unexecuted jobs closer to the top of the list.

In T52, the terminal 10 receives selection of the serial number SNB on top of the list in the selection screen SC1. In response, a WFD connection is established between the terminal 10 and the printer 100B identified by the serial number SNB in T54. Specifically, the printer 100B is operating as a Group Owner of the WFD scheme (i.e., as parent station) at the time of T52. In response to the serial number SNB being selected in the terminal 10 (T52), communication such as 4-way handshake, etc. is executed between the terminal 10 and the printer 100B and a WFD connection is thereby established between the terminal 10 and the printer 100B. That is, the terminal 10 and the printer 100B belong to the same Wi-Fi network, for example, in which the printer 100B operates as a Group Owner of the WFD scheme. In a modification, the printer 100B may not be operating as a Group Owner at the time of T52. In this case, when the serial number SNB is selected in the terminal 10 and a trigger operation to establish a WFD connection is performed in the printer 100B, G/O Negotiation may be executed to determine which one of the terminal 10 and the printer 100B is to operate as a Group Owner. After this, communication such as 4-way handshake, etc. may be executed between the terminal 10 and the printer 100B to establish a WFD connection between the terminal 10 and the printer 100B.

In T56, the terminal 10 converts the image to be printed, which was selected in T12, to print data and sends a print instruction including the print data to the printer 100B using the established WFD connection (i.e., Wi-Fi network). The print data has a data format that the printer 100B can interpret.

In response to receiving the print data from the terminal 10 in T56, the printer 100B executes printing according to the print data in T60. Thus, the user can get a material printed by the printer 100B. Once the printing is completed, the WFD connection between the terminal 10 and the printer 100B is disconnected in T62.

### Advantageous Effects of Embodiment

According to the configuration above, the terminal 10 sends a Subscribe to the printers 100A to 100D within the same NAN cluster according to the Wi-Fi Aware scheme (T24 in FIG. 3). In response, the printers 100A to 100D send Publishes including their usage information to the terminal 10 (T30). Further, between the terminal 10 and each of the printers 100A to 100D, communication is executed to measure the distances therebetween (T34 to T38 in FIG. 3, and FIG. 5). The terminal 10 then specifies the distances between the terminal 10 and the printers 100A to 100D and the statuses of the printers 100A to 100D (T40 in FIG. 3), and displays the selection screen SC1 based on the distances and statuses (T50 in FIG. 4). Then, in response to the serial number SNB being selected by the user in the selection screen SC1 (T52), a WFD connection according to the WFD scheme is established between the terminal 10 and the printer 100B (T54). That is, the terminal 10 and the printer 100B belong to the same Wi-Fi network. Thereafter, the terminal 10 sends a print data to the printer 100B using the Wi-Fi network (T56). The printer 100B receives the print data from the terminal 10 and executes printing according to the print data (T60). Thus, a novel technology for the terminal 10 to cause any one of the printers 100A to 100D belonging to the NAN cluster to execute printing is implemented.

### Correspondence Relationships

The terminal 10 is an example of “communication device”. The four printers 100A to 100D are examples of “M image processing devices” and “N image processing devices”. The display 14 is an example of “output unit”. The print executing unit 118 is an example of “image processing unit”. The four serial numbers SNA to SND are an example of “N identification information”. The printer 100B and the serial number SNB are examples of “specific image processing device” and “specific identification information”, respectively. The Subscribe of T24 and the Publish of T30 in FIG. 3 are examples of “search signal” and “response signal”, respectively. The print instruction of T56 in FIG. 4 is an example of “processing instruction”. The FTM response of T110 and the ACK of T112 in FIG. 5 are examples of “first signal” and “second signal”, respectively. The Wi-Fi Aware scheme and the WFD scheme are examples of “first scheme” and “second scheme”, respectively.

Correspondence relationships as to “communication device” are as follows. T24 to T32 and T34 to T38 in FIG. 3 are examples of “search for one or more image processing devices”. T40 in FIG. 3 is an example of “specify a distance”. T50 in FIG. 4 is an example of “cause an output unit to output N identification information”. T54 in FIG. 4 is an example of “join, via the Wi-Fi interface, a same Wi-Fi network to which a specific image processing device identified by the specific identification information belongs”. T56 in FIG. 4 is an example of “send a process instruction”.

Correspondence relationships as to “specific image processing device” are as follows. T30 in FIG. 3 executed by the printer 100B is an example of “send the communication device a response signal”. T54 in FIG. 4 is an example of “join, via the Wi-Fi interface, a same Wi-Fi network to which the communication device belongs”. T56 in FIG. 4 is an example of “receive a processing instruction”. T60 in FIG. 4 is an example of “cause the image processing unit to execute the image processing”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(Modification 1) In T54 of FIG. 4, the terminal 10 and the printer 100B may belong to a Wi-Fi network in which the terminal 10 operates as a Group Owner of the WFD scheme. In this modification, the Wi-Fi network in which the terminal 10 operates as a Group Owner is an example of “Wi-Fi network”. In another modification, in T54 of FIG. 4, the terminal 10 and the printer 100B may belong to a Wi-Fi network formed by an access point (not shown). In this modification, the Wi-Fi network formed by the access point is an example of “Wi-Fi network”. In yet another modification, in T54 of FIG. 4, the terminal 10 and the printer 100B may belong to a Wi-Fi network in which the printer 100B operates as a SoftAP. In this modification, the Wi-Fi network formed by the printer 100B operating as a SoftAP is an example of “Wi-Fi network”. In still another modification, in T54 of FIG. 4, the terminal 10 and the printer 100B may belong to a Wi-Fi network in which the terminal 10 operates as a SoftAP. In this modification, the Wi-Fi network formed by the terminal 10 operating as a SoftAP is an example of “Wi-Fi network”.

(Modification 2) In T30 of FIG. 3, the printer 100A may send a Publish that does not include the usage information to the terminal 10. In this case, the terminal 10 may display the selection screen SC1 that does not include any usage numbers in T50 of FIG. 4. Especially, the selection screen SC1 displayed in this modification may not preferentially display serial numbers of printers having smaller usage numbers.

(Modification 3) In T50 of FIG. 4, instead of determining the display order of the serial numbers of the printers based on the usage numbers, the terminal 10 may determine the display order based on the information included in the Follow-ups. For example, the terminal 10 may arrange a normally operating printer above a printer in which an error is occurring or may arrange the printers having smaller numbers of unexecuted jobs closer to the top of the list.

(Modification 4) The method of specifying the distances between the terminal 10 and the printers (e.g., 100A) is not limited to the one described in connection with the embodiment above. For example, the terminal 10 may specify the distances between the terminal 10 and the printers based on radio field intensities of signals received from the printers.

(Modification 5) The terminal 10 may search for one or more printers present around the terminal 10 according to a different scheme from the Wi-Fi Aware scheme. In this modification, the different scheme is an example of “first scheme”.

(Modification 7) In the embodiment above, the steps in FIGS. 3 to 5 are implemented by software (e.g., OS 36, app 38, program 136), however, at least one of them may be implemented by hardware such as a logic circuit.

What is claimed is:

1. A communication device comprising:
a Wi-Fi interface configured for Wi-Fi communication according to a Wi-Fi standard; and
a controller,
wherein the controller is configured to:
search for one or more image processing devices present around the communication device via the Wi-Fi interface according to a first scheme of the Wi-Fi standard, wherein the one or more image processing devices do not currently belong to a same Wi-Fi network to which the communication device belongs;
for each of M image processing devices found in the search, specify a distance between the image processing device and the communication device, wherein the M is an integer equal to or greater than 1;
cause an output unit to output N identification information for identifying N image processing devices among the M image processing devices based on the specified distances of the M image processing devices, wherein the N is an integer equal to or greater than 1 and equal to or less than the M;
in a case where specific identification information is selected by a user from the N identification information, join, via the Wi-Fi interface, a same Wi-Fi network to which a specific image processing device identified by the specific identification information belongs according to a second scheme of the Wi-Fi standard different from the first scheme; and
send a process instruction for instructing image processing to be executed to the specific image processing device via the Wi-Fi interface by using the Wi-Fi network.

2. The communication device as in claim 1,
wherein the first scheme is a Wi-Fi Aware scheme.

3. The communication device as in claim 1,
wherein the second scheme is one of: a normal Wi-Fi scheme which uses an access point different from the communication device and the specific image processing device, a Wi-Fi Direct scheme, and a SoftAP scheme.

4. The communication device as in claim 1,
wherein the controller is configured to, for each of the M image processing devices, specify the distance between the image processing device and the communication device based on a time related to communication of a first signal sent from the image processing device and a time related to communication of a second signal sent to the image processing device.

5. The communication device as in claim 1
wherein the controller is configured to search for the one or more image processing devices that do not currently belong to the same Wi-Fi network to which the communication device belongs without executing communication of a network layer or higher layer of an OSI reference model.

6. A specific image processing device comprising:
an image processing unit;
a Wi-Fi interface configured for Wi-Fi communication according to a Wi-Fi standard; and
a controller,
wherein the controller is configured to:
in a case where a search signal according to a first scheme of the Wi-Fi standard is received via the Wi-Fi interface from a communication device that does not currently belong to a same Wi-Fi network to which the specific image processing device belongs, send the communication device a response signal according to the first scheme, wherein based on response signals sent from M image processing devices including the specific image processing device, N identification information for identifying N image processing devices among the M image processing devices is outputted in the communication device, wherein the M is an integer equal to or greater than 1 and the N is an integer equal to or greater than 1 and equal to or less than the M;
in a case where specific identification information for identifying the specific image processing device is selected by a user from the N identification information, join, via the Wi-Fi interface, a same Wi-Fi network to which the communication device belongs according to a second scheme of the Wi-Fi standard different from the first scheme;
receive a process instruction for instructing image processing to be executed from the communication device via the Wi-Fi interface by using the Wi-Fi network; and
in a case where the process instruction is received from the communication device, cause the image processing unit to execute the image processing.

7. The specific image processing device as in claim 6,
wherein the first scheme is a Wi-Fi Aware scheme.

8. The specific image processing device as in claim 6,
wherein the second scheme is one of: a normal Wi-Fi scheme which uses an access point different from the communication device and the specific image processing device, a Wi-Fi Direct scheme, and a SoftAP scheme.

9. The specific image processing device as in claim 6,
wherein the search signal and the response signals are signals of layers lower than a network layer of an OSI reference model.

10. A non-transitory computer-readable recording medium storing computer-readable instructions for a communication device,
wherein the communication device comprises:
a Wi-Fi interface configured for Wi-Fi communication according to a Wi-Fi standard; and
a processor,
wherein the computer-readable instructions, when executed by the processor, cause the communication device to:
search for one or more image processing devices present around the communication device via the Wi-Fi interface according to a first scheme of the Wi-Fi standard, wherein the one or more image processing devices do not currently belong to a same Wi-Fi network to which the communication device belongs;
for each of M image processing devices found in the search, specify a distance between the image processing device and the communication device, wherein the M is an integer equal to or greater than 1;
cause an output unit to output N identification information for identifying N image processing devices among the M image processing devices based on the specified distances of the M image processing devices, wherein the N is an integer equal to or greater than 1 and equal to or less than the M;
in a case where specific identification information is selected by a user from the N identification information, join, via the Wi-Fi interface, a same Wi-Fi network to which a specific image processing device identified by the specific identification information belongs according to a second scheme of the Wi-Fi standard different from the first scheme; and
send a process instruction for instructing image processing to be executed to the specific image processing device via the Wi-Fi interface by using the Wi-Fi network.

11. A non-transitory computer-readable recording medium storing computer-readable instructions for a specific image processing device,
the specific image processing device comprises:
an image processing unit;
a Wi-Fi interface configured for Wi-Fi communication according to a Wi-Fi standard; and
a processor,
wherein the computer-readable instructions, when executed by the processor, cause the specific image processing device to:
in a case where a search signal according to a first scheme of the Wi-Fi standard is received via the Wi-Fi interface from a communication device that does not currently belong to a same Wi-Fi network to which the specific image processing device belongs, send the communication device a response signal according to the first scheme, wherein based on response signals sent from M image processing devices including the specific image processing device, N identification information for identifying N image processing devices among the M image processing device is outputted in the communication device, wherein the M is an integer equal to or greater than 1 and the N is an integer equal to or greater than 1 and equal to or less than the M;
in a case where specific identification information for identifying the specific image processing device is selected by a user from the N identification information, join, via the Wi-Fi interface, a same Wi-Fi network to which the communication device belongs according to a second scheme of the Wi-Fi standard different from the first scheme;
receive a process instruction for instructing image processing to be executed from the communication device via the Wi-Fi interface by using the Wi-Fi network; and
in a case where the process instruction is received from the communication device, cause the image processing unit to execute the image processing.
